(19) United States
(12) Patent Application Publication
(10) Pub. No.: US 2023/0198294 A1
(43) Pub. Date: Jun. 22, 2023

(54) SYSTEM FOR MONITORING AND MANAGEMENT OF ELECTRICAL SYSTEM

(71) Applicant: Microsoft Technology Licensing, LLC, Redmond, WA (US)

(72) Inventors: Imran SIDDIQUE, Bellevue, WA (US); Nayana Singh PATEL, Mercer Island, WA (US); Tianna S. WARD, Issaquah, WA (US)

(73) Assignee: Microsoft Technology Licensing, LLC, Redmond, WA (US)

(21) Appl. No.: 17/654,983

(22) Filed: Mar. 15, 2022

Related U.S. Application Data
(60) Provisional application No. 63/265,570, filed on Dec. 16, 2021.

(51) Int. Cl. H02J 13/00; H02J 3/46; H02J 3/38; H02J 3/14

(52) U.S. Cl. CPC H02J 13/00002; H02J 3/466; H02J 3/381; H02J 3/14; G06Q 50/06

(57) ABSTRACT

A computing system is provided for intelligent monitoring and management of an electrical system. The system receives electrical usage data and electrical production data via a computer network from a plurality of grid agents at a plurality of points across the electrical system; receives a privacy permission from an owner of one of the plurality of grid agents; based on the privacy permission, authorize sharing of a shareable portion of the electrical usage data and/or a shareable portion of the electrical production data and restrict sharing of a restricted portion of the electrical usage data and/or a restricted portion of the electrical production data; and executes a prediction model which processes patterns observed in the shareable portion of the electrical usage data and the shareable portion of the electrical production data, and predicts a forecasted aspect of the electrical system; and outputs the forecasted aspect of the electrical system.

### CROSS REFERENCE TO RELATED APPLICATIONS

This application claims priority to U.S. Provisional Patent Application No. 63/265,570 filed Dec. 16, 2021, the entirety of which is hereby incorporated herein by reference.

### BACKGROUND

The electrical grid is an interconnected network of equipment, devices, wires, and structures that brings electricity from where it is generated to where it is consumed. There are 3 major functions within the value chain that enable consumption: (1) the production of electricity from a primary fuel source, (2) the transmission from production through the network, and (3) the distribution across a range of distances. However, utility companies are facing aging infrastructure, operational challenges, and technological disruptions. In addition, they face climate change driven regulatory carbon targets, and changes in their supply mix fueling variability of renewable energy. As more regions adopt a low carbon target, the pressure to balance the higher share of renewable generation with distribution flexibility will create grid instability and exponentially increase utilities' costs. Utilities and grid operators look for solutions to defer capital expenditures, reduce fuel and balancing assets, and avoid the high cost of carbon capture and storage technologies required to decarbonize thermal generation assets. End consumers look to alleviate some costs associated with the industry moving towards higher penetration of renewable energy.

### SUMMARY

In view of the above background context, a computing system is provided for intelligent monitoring and management of an electrical system. The system comprises: a processor and a non-volatile memory storing executable instructions that, in response to execution by the processor, cause the processor to: receive electrical usage data and electrical production data via a computer network from a plurality of grid agents that measure electrical usage and electrical production, respectively, at a plurality of points across the electrical system; store the electrical usage data and the electrical production data in a database, the electrical usage data and the electrical production data being categorized in the database as originating from at least two of an end consumer, energy producer, grid operator, or local distributor; receive a privacy permission from an owner of one of the plurality of grid agents; based on the privacy permission, authorize sharing of a shareable portion of the electrical usage data and/or a shareable portion of the electrical production data and restrict sharing of a restricted portion of the electrical usage data and/or a restricted portion of the electrical production data; execute a prediction model which receives the shareable portion of the electrical usage data and the shareable portion of the electrical production data, processes patterns observed in the shareable portion of the electrical usage data and the shareable portion of the electrical production data, and predicts a forecasted aspect of the electrical system; and output the forecasted aspect of the electrical system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing environment in which the computer device of FIG. 1 may be enacted.

FIG. 2 shows a detailed view of the schematic view of FIG. 1.

FIG. 3 shows a schematic view of the computing device of FIGS. 1 and 2 and the database in which privacy permissions are stored.

FIG. 4 is a flowchart of a method for intelligent monitoring and management of an electrical system according to an example of the present disclosure.

FIG. 5 shows a computing system according to an embodiment of the present disclosure.

### DETAILED DESCRIPTION

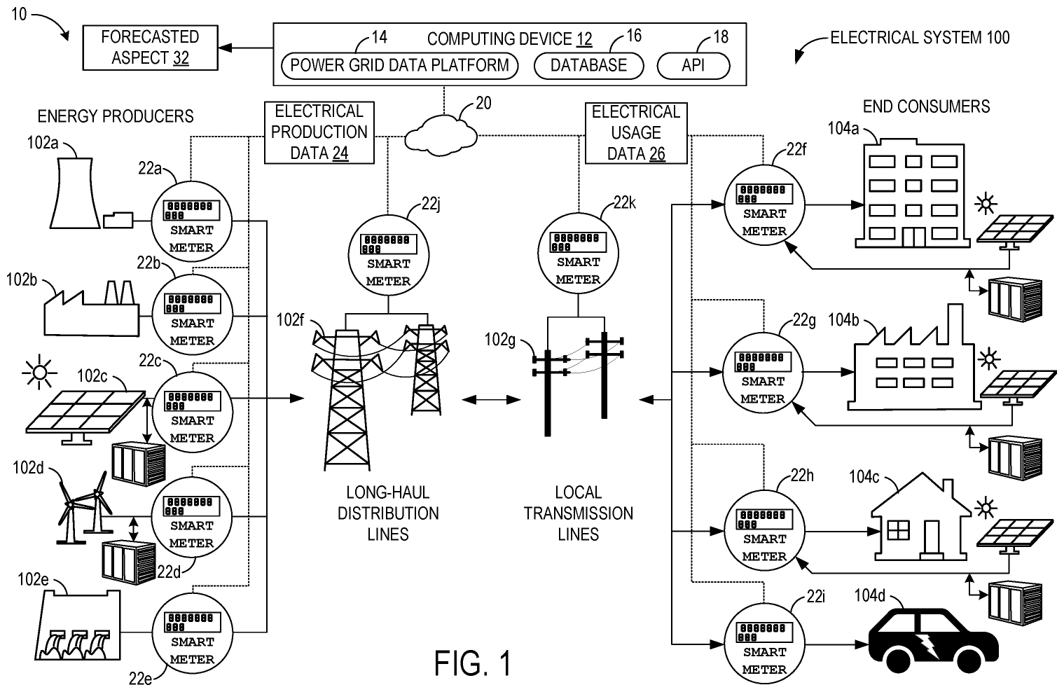

FIG. 1 is a schematic diagram of an illustrative computing system 10 to predict a forecasted aspect 32 of an electrical system 100, which may be an electrical grid connected to energy producers 102a-g and end consumers 104a-d. The computing system 10 includes a computing device 12 which may be a server, among other possible computing devices. The computing device 12 instantiates a power grid data platform 14 as discussed further below.

The system 100 further includes a computer network 20 connected to the computing device 12 and an electrical system 100 that includes distribution control to transmit power along transmission lines from a plurality of energy producers 102a-g to a plurality of end consumers 104a-d, which connect at various locations downstream from the energy producers 102a-g. Some end consumers 104a-d may be “prosumers,” which are consumers who locally produce power using generators and batteries, for example.

In this example, the energy producers 102a-g include nuclear power plants, coal electric plants, solar panels, wind farms, and hydroelectric dams. The end consumers 104a-d include commercial buildings, factories, residential homes, and electric cars.

In the electrical system 100, grid agents 22a-k are provided for each energy producer, distribution line, transmission line, and end consumer in the electrical system 100. The grid agents 22a-k can be embodied as electronic meters measuring electrical usage and electrical production at a plurality of points across the electrical system 100.

The computing device 12 receives electrical usage data 26 and electrical production data 24 via a computer network 20 from the plurality of grid agents 22a-k. The electrical usage data 26 and electrical production data 24 may be real-time telemetry data. An application-programming interface (API) 18 may serve as an interface between the computing device 12 and the grid agents 22a-k. The computing device 12 stores the electrical usage data 26 and the electrical production data 24 in a database 16, executes a prediction model 30 to process patterns observed in a shareable portion of the electrical usage data 26 and a shareable portion of the electrical production data 24, and predicts a forecasted aspect 32 of the electrical system 100. The forecasted aspect 32 of the electrical system 100 is outputted by the computing device 12.

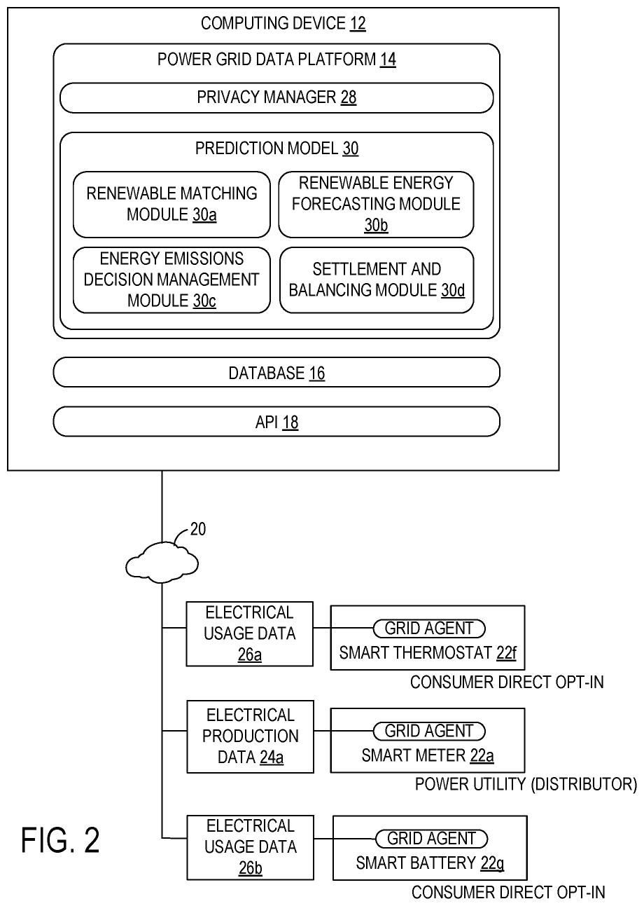

Referring to FIG. 2, the power grid data platform 14 includes the prediction model 30 and a privacy manager 28. Although the privacy manager 28 is illustrated as being incorporated on the device, it could be implemented by a trusted entity such as a trusted server that is not part of the mobile computing device 12. The privacy manager 28 can be implemented in any suitable hardware, software, firmware or combination thereof. In the illustrated example, the privacy manager 28 comprises a software module that is incorporated in the computing device 12.

The privacy manager 28 addresses privacy concerns that are associated with the information that is collected by the computing device 12. It is entirely likely that an owner of a grid agent does not want certain portions of the electrical usage data 26 or electrical production data 24 to be shared with others or provided to untrusted applications. For each owner, a privacy policy can be defined. For example, each privacy policy can be defined by a privacy level.

The privacy manager 28 ensures that personal or high-value information traversing public networks and stored on the computing device 12 is only disclosed to authorized entities. Additionally, the privacy manager 28 maintains data integrity of all types of data and information traversing and/or stored on public servers, thereby preventing unauthorized modification of transmitted data that is in transit between one or more entities.

The prediction model 30 may further include a settlement and balancing module 30d configured to process the forecasted aspect 32 to release or curtail energy supply using the plurality of grid agents 22a-k of the electrical system 100 based on the forecasted aspect 32. The forecasted aspect 32 of the electrical system 100 may be forecasted by using a power consumption policy specifying target power loads. The power consumption policy may specify different target power loads for different spatial regions from different grid operators or local distributors.

The energy supply may be released by sending a message to a grid agent of one of the energy producers 102a-g to increase energy production, or by sending a message to a grid agent of one of the end consumers 104a-d to reduce energy consumption. The energy supply may also be released by causing one or more computers and/or associated electronic devices of one of the end consumers 104a-d to reduce power consumption.

The energy supply may be curtailed by sending a message to a grid agent of one of the energy producers 102a-g to reduce energy production or increase storage of produced energy, or by sending a message to a grid agent of one of the end consumers 104a-d to increase energy consumption or increase storage of produced energy. The energy supply may also be curtailed by causing one or more computers and/or associated electronic devices of one of the end consumers 104a-d to increase power consumption.

The prediction model 30 may also include a renewable energy forecasting module 30b to track the carbon footprint of each energy producer 102a-g and end consumer 104a-d, a renewable matching module 30a to prioritize the use of energy from renewable energy producers 102a-g, and an energy emissions decision management module 30c to balance the energy production of the energy producers 102a-g and the energy consumption of the end consumers 104a-d to minimize greenhouse gas emissions.

In the example of FIG. 2, the grid agents 22f, 22g of the end consumers 104a, 104b are a smart thermostat 22f and a smart battery 22g, respectively, and the grid agent 22a of the energy producer 102a, a power utility, is a smart meter 22a. The smart thermostat 22f and the smart battery 22g send their respective electrical usage data 26a, 26b to the computing device 12, while the smart meter 22a sends electrical production data 24a to the computing device 12.

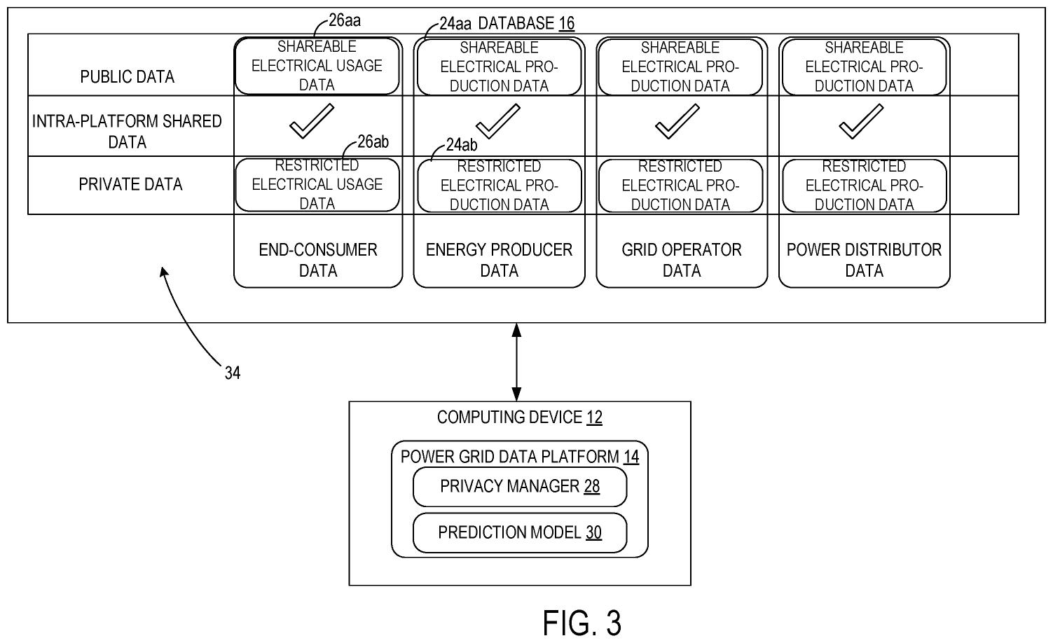

Referring to FIG. 3, the privacy manager 28 receives privacy permissions 34 from owners of the plurality of grid agents 22a-k, and stores the privacy permissions 34 of owners of the grid agents 22a-k in a database 16. Although the database 16 is depicted as being external to the computing device 12, it will be appreciated that the database 16 can alternatively be hosted within the computing device 12. The database 16 includes authorizations to share shareable portions of the electrical usage data 26 and electrical production data 24 of the grid agents 22a-k, and restrictions to designate restricted portions of the electrical usage data 26 and electrical production data 24 of the grid agents 22a-k.

The shareable portions of the electrical usage data 26 and electrical production data 24 of the grid agents 22a-k are received by the prediction model 30 and used to predict a forecasted aspect 32 of the electrical system 100, while the restricted portions of the electrical usage data 26 and electrical production data 24 of the grid agents 22a-k are not received by the prediction model 30, and not used to predict a forecasted aspect 32 of the electrical system 100.

In this example, the electrical usage data 26 and the electrical production data 24 are categorized in the database 16 as originating from an end consumer, energy producer, grid operator, or local distributor. The electrical usage data 26a of the end consumer is divided into a shareable portion 26aa and a restricted portion 26ab. The electrical production data 24 of the energy producer, grid operator, and power distributor is divided into a shareable portion 24aa and a restricted portion 24ab.

Among the levels of privacy permission there may be a “public” option that enables a participant in the power grid as described above to designate that certain data may be publicly accessible by regulator agencies, news agencies, and academics, for example, for use in reporting aspects of the power production, transmission and consumption, as well as aspects of renewable demand. The results can be published on a resilient storage ledger for later public inspection, using blockchain technologies.

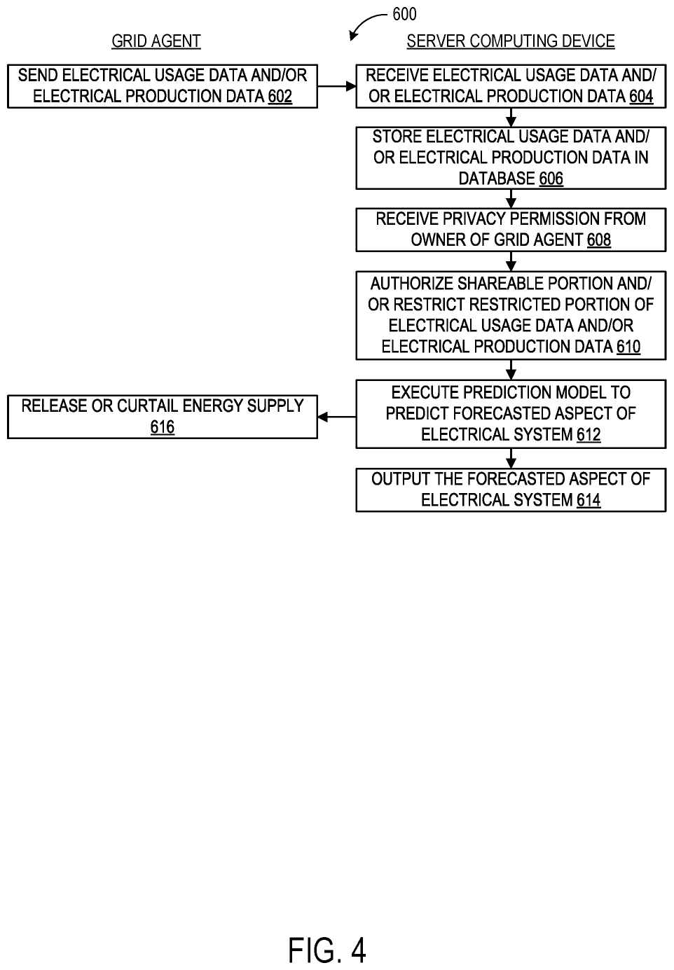

FIG. 4 illustrates a flow chart of a method 600 for intelligent monitoring and management of an electrical system 100 according to an example of the present disclosure. The following description of method 600 is provided with reference to the software and hardware components described above and shown in FIGS. 1-4. It will be appreciated that method 600 also may be performed in other contexts using other suitable hardware and software components.

With reference to FIG. 4, at step 602 the method 600 includes the grid agent sending electrical usage data 26 and/or electrical production data 24 to the computing device 12. At step 604, the computing device 12 receives electrical usage data 26 and/or electrical production data 24 via a computer network 20 from a plurality of grid agents 22a-k that measure electrical usage and electrical production, respectively, at a plurality of points across an electrical system 100. At step 606, the computing device 12 stores the electrical usage data 26 and the electrical production data 24 in a database 16, the electrical usage data 26 and the electrical production data 24 being categorized in the database 16 as originating from at least two of, possibly three of, and in some cases all of, an end consumer, energy producer, grid operator, or local distributor.

At step 608, the computing device 12 receives a privacy permission from an owner of one of the plurality of grid agents 22a-k. At step 610, the computing device 12 authorizes sharing of a shareable portion of the electrical usage data 26 and/or a shareable portion of the electrical production data 24 and restricts sharing of a restricted portion of the electrical usage data 26 and/or a restricted portion of the electrical production data 24, based on the privacy permission.

At step 612, the computing device 12 executes a prediction model 30 which receives the shareable portion of the electrical usage data 26 and the shareable portion of the electrical production data 24, processes patterns observed in the shareable portion of the electrical usage data 26 and the shareable portion of the electrical production data 24, and predicts a forecasted aspect 32 of the electrical system 100. At step 614, the computing device 12 outputs the forecasted aspect 32 of the electrical system 100. At step 616, the grid agent releases or curtails energy supply based on the forecasted aspect 32.

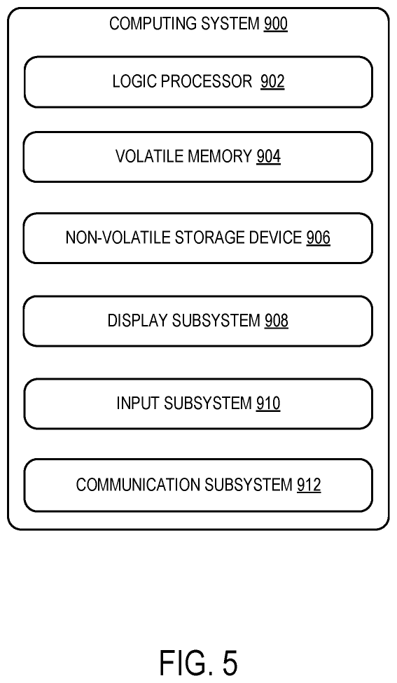

FIG. 5 schematically shows a non-limiting embodiment of a computing system 900 that can enact one or more of the methods and processes described above. Computing system 900 is shown in simplified form. Computing system 900 may embody the computing device 12 of FIG. 1 or the grid agents 22a-k of FIGS. 1-3. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 904, and a non-volatile storage device 906. Computing system 900 may optionally include a display subsystem 908, input subsystem 910, communication subsystem 912, and/or other components not shown in FIG. 5.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 may include physical devices that are removable and/or built-in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database 16 records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wireless telephone network, or a wired or wireless local- or wide-area network, such as Bluetooth and HDMI over Wi-Fi connection. In some embodiments, the communication subsystem may allow computing system 900 to send and/or receive messages to and/or from other devices via a network such as the Internet.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The following paragraphs provide additional support for the claims of the subject application. One aspect provides a computing system for intelligent monitoring and management of an electrical system, the system comprising: a processor and a non-volatile memory storing executable instructions that, in response to execution by the processor, cause the processor to: receive electrical usage data and electrical production data via a computer network from a plurality of grid agents that measure electrical usage and electrical production, respectively, at a plurality of points across the electrical system; store the electrical usage data and the electrical production data in a database, the electrical usage data and the electrical production data being categorized in the database as originating from at least two of an end consumer, energy producer, grid operator, or local distributor; receive a privacy permission from an owner of one of the plurality of grid agents; based on the privacy permission, authorize sharing of a shareable portion of the electrical usage data and/or a shareable portion of the electrical production data and restrict sharing of a restricted portion of the electrical usage data and/or a restricted portion of the electrical production data; execute a prediction model which receives the shareable portion of the electrical usage data and the shareable portion of the electrical production data, processes patterns observed in the shareable portion of the electrical usage data and the shareable portion of the electrical production data, and predicts a forecasted aspect of the electrical system; and output the forecasted aspect of the electrical system. In this aspect, additionally or alternatively, the prediction model may further include: a settlement and balancing module configured to process the forecasted aspect to release or curtail energy supply using the plurality of grid agents of the electrical system based on the forecasted aspect. In this aspect, additionally or alternatively, the energy supply may be released by sending a message to a grid agent of the energy producer to increase energy production, or by sending a message to a grid agent of the end consumer to reduce energy consumption. In this aspect, additionally or alternatively, the energy supply may be released by causing one or more computers and/or associated electrical devices of the end consumer to reduce power consumption. In this aspect, additionally or alternatively, the energy supply may be curtailed by sending a message to a grid agent of the energy producer to reduce energy production or increase storage of produced energy, or by sending a message to a grid agent of the end consumer to increase energy consumption or increase storage of produced energy. In this aspect, additionally or alternatively, the energy supply may be curtailed by causing one or more computers and/or associated electrical devices of the end consumer to increase power consumption or increase storage of produced energy. In this aspect, additionally or alternatively, the forecasted aspect of the electrical system may be forecasted by using a power consumption policy specifying target power loads. In this aspect, additionally or alternatively, the power consumption policy specifies different target power loads for different spatial regions from different grid operators or local distributors. In this aspect, additionally or alternatively, the prediction model further includes a renewable energy forecasting module to track a carbon footprint of each energy producer and end consumer. In this aspect, additionally or alternatively, the prediction model further includes an energy emissions decision management module to balance an energy production of a plurality of energy producers and an energy consumption of a plurality of end consumers to minimize greenhouse gas emissions.

Another aspect provides a method for intelligent monitoring and management of an electrical system, the method comprising: receiving electrical usage data and electrical production data via a computer network from a plurality of grid agents that measure electrical usage and electrical production, respectively, at a plurality of points across the electrical system; storing the electrical usage data and the electrical production data in a database, the electrical usage data and the electrical production data being categorized in the database as originating from at least two of an end consumer, energy producer, grid operator, or local distributor; receiving a privacy permission from an owner of one of the plurality of grid agents; based on the privacy permission, authorizing sharing of a shareable portion of the electrical usage data and/or a shareable portion of the electrical production data and restricting sharing of a restricted portion of the electrical usage data and/or a restricted portion of the electrical production data; executing a prediction model which receives the shareable portion of the electrical usage data and the shareable portion of the electrical production data, processes patterns observed in the shareable portion of the electrical usage data and the shareable portion of the electrical production data, and predicts a forecasted aspect of the electrical system; and outputting the forecasted aspect of the electrical system. In this aspect, additionally or alternatively, the prediction model may further include: a settlement and balancing module configured to process the forecasted aspect to release or curtail energy supply using the plurality of grid agents of the electrical system based on the forecasted aspect. In this aspect, additionally or alternatively, the energy supply may be released by sending a message to a grid agent of the energy producer to increase energy production, or by sending a message to a grid agent of the end consumer to reduce energy consumption. In this aspect, additionally or alternatively, the energy supply may be released by causing one or more computers and/or associated electrical devices of the end consumer to reduce power consumption. In this aspect, additionally or alternatively, the energy supply may be curtailed by sending a message to a grid agent of the energy producer to reduce energy production or increase storage of produced energy, or by sending a message to a grid agent of the end consumer to increase energy consumption or increase storage of produced energy. In this aspect, additionally or alternatively, the energy supply may be curtailed by causing one or more computers of the end consumer to increase power consumption or increase storage of produced energy. In this aspect, additionally or alternatively, the forecasted aspect of the electrical system may be forecasted by using a power consumption policy specifying target power loads. In this aspect, additionally or alternatively, the power consumption policy may specify different target power loads for different spatial regions from different grid operators or local distributors. In this aspect, additionally or alternatively, the prediction model may further include a renewable energy forecasting module to track a carbon footprint of each energy producer and end consumer.

Another aspect provides a computing system for intelligent monitoring and management of an electrical system, the system comprising: a processor and a non-volatile memory storing executable instructions that, in response to execution by the processor, cause the processor to: receive electrical usage data and electrical production data via a computer network from a plurality of grid agents that measure electrical usage and electrical production, respectively, at a plurality of points across the electrical system; store the electrical usage data and the electrical production data in a database, the electrical usage data and the electrical production data being categorized in the database as originating from at least two of an end consumer, energy producer, grid operator, or local distributor; receive a privacy permission from an owner of one of the plurality of grid agents; based on the privacy permission, authorize sharing of a shareable portion of the electrical usage data and/or a shareable portion of the electrical production data and restrict sharing of a restricted portion of the electrical usage data and/or a restricted portion of the electrical production data; execute a prediction model which receives the shareable portion of the electrical usage data and the shareable portion of the electrical production data, processes patterns observed in the shareable portion of the electrical usage data and the shareable portion of the electrical production data, and predicts a forecasted aspect of the electrical system; and process the forecasted aspect to release or curtail energy supply using the plurality of grid agents of the electrical system based on the forecasted aspect.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for intelligent monitoring and management of an electrical system, the system comprising:
a processor and a non-volatile memory storing executable instructions that, in response to execution by the processor, cause the processor to:
receive electrical usage data and electrical production data via a computer network from a plurality of grid agents that measure electrical usage and electrical production, respectively, at a plurality of points across the electrical system;
store the electrical usage data and the electrical production data in a database, the electrical usage data and the electrical production data being categorized in the database as originating from at least two of an end consumer, energy producer, grid operator, or local distributor;
receive a privacy permission from an owner of one of the plurality of grid agents;
based on the privacy permission, authorize sharing of a shareable portion of the electrical usage data and/or a shareable portion of the electrical production data and restrict sharing of a restricted portion of the electrical usage data and/or a restricted portion of the electrical production data;
execute a prediction model which receives the shareable portion of the electrical usage data and the shareable portion of the electrical production data, processes patterns observed in the shareable portion of the electrical usage data and the shareable portion of the electrical production data, and predicts a forecasted aspect of the electrical system; and
output the forecasted aspect of the electrical system.

2. The computing system of claim 1, wherein the prediction model further includes:
a settlement and balancing module configured to process the forecasted aspect to release or curtail energy supply using the plurality of grid agents of the electrical system based on the forecasted aspect.

3. The computing system of claim 2, wherein the energy supply is released by sending a message to a grid agent of the energy producer to increase energy production, or by sending a message to a grid agent of the end consumer to reduce energy consumption.

4. The computing system of claim 3, wherein the energy supply is released by causing one or more computers and/or associated electrical devices of the end consumer to reduce power consumption.

5. The computing system of claim 2, wherein the energy supply is curtailed by sending a message to a grid agent of the energy producer to reduce energy production or increase storage of produced energy, or by sending a message to a grid agent of the end consumer to increase energy consumption or increase storage of produced energy.

6. The computing system of claim 5, wherein the energy supply is curtailed by causing one or more computers and/or associated electrical devices of the end consumer to increase power consumption or increase storage of produced energy.

7. The computing system of claim 1, wherein the forecasted aspect of the electrical system is forecasted by using a power consumption policy specifying target power loads.

8. The computing system of claim 9, wherein the power consumption policy specifies different target power loads for different spatial regions from different grid operators or local distributors.

9. The computing system of claim 1, wherein the prediction model further includes a renewable energy forecasting module to track a carbon footprint of each energy producer and end consumer.

10. The computing system of claim 1, wherein the prediction model further includes an energy emissions decision management module to balance an energy production of a plurality of energy producers and an energy consumption of a plurality of end consumers to minimize greenhouse gas emissions.

11. A method for intelligent monitoring and management of an electrical system, the method comprising:
receiving electrical usage data and electrical production data via a computer network from a plurality of grid agents that measure electrical usage and electrical production, respectively, at a plurality of points across the electrical system;
storing the electrical usage data and the electrical production data in a database, the electrical usage data and the electrical production data being categorized in the database as originating from at least two of an end consumer, energy producer, grid operator, or local distributor;
receiving a privacy permission from an owner of one of the plurality of grid agents;
based on the privacy permission, authorizing sharing of a shareable portion of the electrical usage data and/or a shareable portion of the electrical production data and restricting sharing of a restricted portion of the electrical usage data and/or a restricted portion of the electrical production data;
executing a prediction model which receives the shareable portion of the electrical usage data and the shareable portion of the electrical production data, processes patterns observed in the shareable portion of the electrical usage data and the shareable portion of the electrical production data, and predicts a forecasted aspect of the electrical system; and
outputting the forecasted aspect of the electrical system.

12. The method of claim 11, wherein the prediction model further includes:
a settlement and balancing module configured to process the forecasted aspect to release or curtail energy supply using the plurality of grid agents of the electrical system based on the forecasted aspect.

13. The method of claim 12, wherein the energy supply is released by sending a message to a grid agent of the energy producer to increase energy production, or by sending a message to a grid agent of the end consumer to reduce energy consumption.

14. The method of claim 13, wherein the energy supply is released by causing one or more computers and/or associated electrical devices of the end consumer to reduce power consumption.

15. The method of claim 12, wherein the energy supply is curtailed by sending a message to a grid agent of the energy producer to reduce energy production or increase storage of produced energy, or by sending a message to a grid agent of the end consumer to increase energy consumption or increase storage of produced energy.

16. The method of claim 15, wherein the energy supply is curtailed by causing one or more computers of the end consumer to increase power consumption or increase storage of produced energy.

17. The method of claim 11, wherein the forecasted aspect of the electrical system is forecasted by using a power consumption policy specifying target power loads.

18. The method of claim 17, wherein the power consumption policy specifies different target power loads for different spatial regions from different grid operators or local distributors.

19. The method of claim 11, wherein the prediction model further includes a renewable energy forecasting module to track a carbon footprint of each energy producer and end consumer.

20. A computing system for intelligent monitoring and management of an electrical system, the system comprising:
a processor and a non-volatile memory storing executable instructions that, in response to execution by the processor, cause the processor to:
receive electrical usage data and electrical production data via a computer network from a plurality of grid agents that measure electrical usage and electrical production, respectively, at a plurality of points across the electrical system;
store the electrical usage data and the electrical production data in a database, the electrical usage data and the electrical production data being categorized in the database as originating from at least two of an end consumer, energy producer, grid operator, or local distributor;
receive a privacy permission from an owner of one of the plurality of grid agents;
based on the privacy permission, authorize sharing of a shareable portion of the electrical usage data and/or a shareable portion of the electrical production data and restrict sharing of a restricted portion of the electrical usage data and/or a restricted portion of the electrical production data;
execute a prediction model which receives the shareable portion of the electrical usage data and the shareable portion of the electrical production data, processes patterns observed in the shareable portion of the electrical usage data and the shareable portion of the electrical production data, and predicts a forecasted aspect of the electrical system; and
process the forecasted aspect to release or curtail energy supply using the plurality of grid agents of the electrical system based on the forecasted aspect.
